(19) United States
(12) Patent Application Publication
(10) Pub. No.: US 2004/0149861 A1
(43) Pub. Date: Aug. 5, 2004

(54) S & H Cycle Engine

(76) Inventors: William Charles Strobl, Carlsbad, CA (US); Joe Paschal Holland, Redlands, CA (US)

Correspondence Address: William C. Strobl, 2906 Via Pepita, Carlsbad, CA, 92009, US

(21) Appl. No.: 10/161,785

(22) Filed: Jun. 5, 2002

Related U.S. Application Data
(60) Provisional application No. 60/296,032, filed on Jun. 6, 2001.

(51) Int. Cl. B64G 1/42

(52) U.S. Cl. 244/172

(57) ABSTRACT

The S & H Cycle Engine will provide very high specific impulse propulsion at a reasonable thrust for fast human or cargo or scientific spacecraft travel to the moon or other planets and/or moons of other planets. Significantly shorter flight times will reduce astronaut sickness from zero gravity effects and space radiation. The same system will also provide enough electrical energy to potentially power an electromagnetic shield to protect human passengers from the energetic charged particle component of solar radiation throughout the flight. The S & H Cycle Engine differs from other electric propulsion devices in that it flows the thruster cryogenic propellant through a heat exchanger before it reaches the thruster as a bottom beat sink for the thermal process that generates the electricity for the electric thrusters. In this manner the thermal efficiency increases significantly, thus increasing the total propulsion system efficiency and hence increase the velocity or payload mass of the spacecraft.

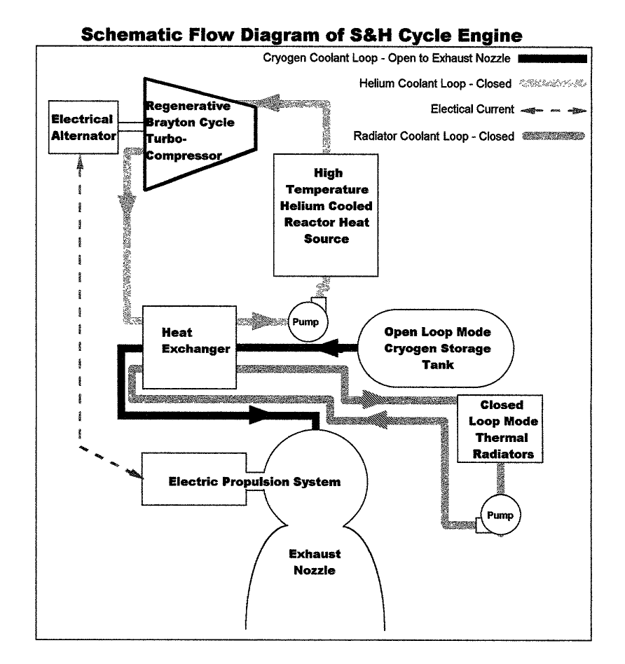

The S & H Cycle Engine will provide very high specific impulse propulsion at a reasonable thrust for fast human or cargo or scientific spacecraft travel to the moon or other planets and/or moons of other planets. Significantly shorter flight times will reduce astronaut sickness from zero gravity effects and space radiation. The same system will also provide enough electrical energy to potentially power an electromagnetic shield to protect human passengers from the energetic charged particle component of solar radiation throughout the flight.

Key Characteristics For Space Application

1. Closed Nuclear Reactor or Solar Collector Loop

2. Open loop low temperature heat sink-Cools electric power generating loop and pre-heats rocket fuel

3. No radioactive exhaust gasses

4. Radiator is sized only for very low power mission phase not for peak power

5. Significantly shorter transfer times to other planet and solar systems over conventional propulsion systems.

6. Higher thrust at high specific impulse allows use as primary propulsion for human space transportation systems.

Since very high specific impulse electric propulsion systems employ a cryogenic propellant (liquid hydrogen, helium or argon), it is an ideal and available natural ultimate heat sink. The low temperature propellant can pass through a heat exchanger absorbing the heat from the reactor-turbine cycle fluid. The propellant is heated to near the radiator exit temperature prior to entering the system thrusters. In turn the reactor-turbine cycle fluid will be chilled to near the initial propellant temperature. Applying this heat exchanger concept in a regenerative power conversion cycle yields the highest system thermal efficiency and the lowest system weight, but requires a flow rate from the propellant higher than the thruster requires for maximum specific impulse.

The higher flow rate does increase the thruster thrust at the same ratio that the specific impulse decreases. Therefore we add a small radiator in between the regenerator and heat exchanger, which slightly compromises the thermal efficiency but maintains the same specific impulse and improves the total system performance. The major net benefits of this concept over prior nuclear electric propulsion system designs are: 1) 34% lower total power generating weight that can be used in any combination to increase margin, safety, reliability, payload, and velocity, 2) 200 K to 300 K lower operating temperatures which simplifies system elements design and operating life, 3) reduces design, manufacturing, development and operating cost, and 4) eliminates thruster thermal shock.

A lower operating temperature allows use of a lower cost commercially operated reactor design. Commercial reactors based upon HTGR technology, which have been developed and operated in the U.S., Germany, U.K., S. Africa and elsewhere over the last 40 years and is experiencing a renaissance, which may make it the basis for the next generation of terrestrial nuclear power stations. This system allows complete ground testing of all aspects of a flight system except for the actual nuclear reactor. The reactor element can be separately and fully tested over the entire operational range as part of a potential terrestrial power plant. This means that a “S&H cycle” propulsion system would not require a unique and prohibitively expensive infrastructure and in fact could be based upon a developing commercial infrastructure.

### STATEMENT REGARDING FEDERALLY SPONSORED RESEARCH OR DEVELOPMENT

The Federal government did not directly sponsor any research or development for the invention of the S & H Cycle Engine. However, most of the elements of the S & H Cycle Engine have had research or development sponsored by different agencies of the Federal Government. The S & H Cycle Engine invention combines elements of nuclear or solar electric propulsion and related propulsion elements in a manner not considered in past designs. Hence, the invention significantly enhances and expands the utility and application of nuclear and solar propulsion for interplanetary and inter solar human and scientific exploration of space in a way never before possible.

### BACKGROUND OF THE INVENTION

The S & H Cycle Engine pertains to transporting satellites, cargo and humans in orbits within the Earth's activity sphere and to other planets and their moons. We suggest that the invention seems to fall into a classification of 244/172 (Aeronautical/Space).

The peak power output of typical space power systems based upon any type of heat engine is limited by the mass and area required by the radiator system that provides the “ultimate beat sink” for the specific power cycle used. Given that these systems are attempting to transfer heat into a vacuum using radiation they will be big in area and require that heat be rejected at high temperatures, typically on the order of 500° F. or greater. Given that the limiting efficiency of a heat engine is the Carnot efficient, (1−Tₕ/Tₗ, Tₕ=Temperature high ° K, Tₗ,=Temperature low ° K) the high Tₗ imposed by the radiator causes the system to have very low thermal efficiencies. Therefore the design trend is that a high Tₗ will cause low thermal efficiencies that increases the amount of heat to be rejected by the radiators which causes the radiator size to increase or the Tₗ to have to increase. The result of this design spiral is that heat engine based space power systems are expensive due to the high temperatures required and the resultant exotic material requirements and produce limited amounts of power, <<1 Megawatt.

The S&H “cycle” attacks both of these problems. By using an open loop cryogenic heat sink, typically LH₂, the radiators do not drive the peak power production of the system. This also allows the thermal efficiency to be greatly increased since the ultimate heat sink temperature, Tₗ , is greatly reduced. This in turn reduces the amount of energy that needs to be rejected which makes an open loop system feasible. The cryogenic mass flow requirements for the S&H cycle are less than for a comparable power NERVA type nuclear thermal rocket. This then enables the use of very high specific impulse electric propulsion systems such as magneto-plasma-dynamic systems.

### BRIEF SUMMARY OF THE INVENTION

Development of High Impulse Electric Propulsion systems has been limited by the size and mass of the heat source and ultimate heat sink. Use of radiation cooling only as the ultimate heat sink for the thermal cycle causes the system efficiency to be low and the operating temperature to be high. The system life becomes limited and the cost high.

The S & H Cycle Engine breaks free of these limitations using basic thermodynamic principles and a new technology alternator. We found that thermal balancing the total power generating system provided the key to defining an optimum propulsion system. The hybrid open/closed loop thermal cycle is a modified Regenerative Cycle that adds a relatively small radiator and a low temperature heat sink. In this manner the heat engine thermal efficiency increases to over 95% during thruster phase. During coast and mission power phase, the heat exchanger is bypassed reducing the thermal efficiency to allow throttling to 3 kWe. We add a new alternator that supplies regulated, controlled high frequency, three-phase power without power processors. The S & H Cycle Engine allows for 1) 50% reduction in reactor and shielding size, 2) 80% reduction in radiator size, 3) thruster propellant preheat to about 250 K to eliminate-thruster thermal shock, 4) operating at 1173 K to remain within proven commercial operating life criteria, 5) simplifies Power Management and Distribution, and 6) over 15% reduction in propulsion system weight.

### DETAILED DESCRIPTION OF THE INVENTION

The S & H Cycle Engine is a low temperature heat sink, hybrid open/closed loop, cycle that employs a high temperature gradient heat exchanger and a open loop low temperature heat sink to increase heat engine thermal efficiency as compared to traditional cycles. The S & H cycle has application in Space propulsion, housekeeping, electromagnetic radiation shielding, and space electric power generating systems. The S & H Cycle is independent of the type of heat source or propulsive device used.

Since very high specific impulse electric propulsion systems employ a cryogenic propellant (liquid hydrogen, helium or argon), it is an ideal and available natural ultimate heat sink. The low temperature propellant can pass through a heat exchanger absorbing the heat from the reactor-turbine cycle fluid. The propellant is heated to near the radiator exit temperature prior to entering the system thrusters. In turn the reactor-turbine cycle fluid will be chilled to near the initial propellant temperature. Applying this heat exchanger concept in a regenerative power conversion cycle yields the highest system thermal efficiency and the lowest system weight, but requires a flow rate from the propellant higher than the thruster requires for maximum specific impulse.

The higher flow rate does increase the thruster thrust at the same ratio that the specific impulse decreases. Therefore we add a small radiator in between the regenerator and heat exchanger, which slightly compromises the thermal efficiency but maintains the same specific impulse and improves the total system performance. The major net benefits of this concept over prior nuclear electric propulsion system designs are: 1) 34% lower total power generating weight that can be used in any combination to increase margin, safety, reliability, payload, and velocity, 2) 200 K to 300 K lower operating temperatures which simplifies system elements design and operating life, 3) reduces design, manufacturing, development and operating cost, and 4) eliminates thruster thermal shock.

A lower operating temperature allows use of a lower cost commercially operated reactor design. Commercial reactors based upon HTGR technology, which have been developed and operated in the U.S., Germany, U.K., S. Africa and elsewhere over the last 40 years and is experiencing a renaissance, which may make it the basis for the next generation of terrestrial nuclear power stations. This system allows complete ground testing of all aspects of a flight system except for the actual nuclear reactor. The reactor element can be separately and fully tested over the entire operational range as part of a potential terrestrial power plant. This means that a “S&H cycle” propulsion system would not require a unique and prohibitively expensive infrastructure and in fact could be based upon a developing commercial infrastructure.

The main difference of the s & h cycle engine to other electric propulsion engine systems is the use of the thruster propellants in the electric power generating and distribution process that produces the electricity required for the thrusters and spacecraft house keeping functions:

1. Electric propulsion to transport unmanned satellites from low Earth orbit to any other orbit throughout the Earth's activity sphere.

2. Electric propulsion to transport unmanned satellites from any Earth orbit to Lunar orbits and Libration Points.

3. Electric propulsion to transport unmanned satellites from any Earth orbit to other planets and their moons.

4. Electric propulsion to transport unmanned scientific satellites from any Earth orbit to escape our solar system activity sphere to explore other solar systems.

5. Electric propulsion to transport humans from low Earth orbit to any other orbit throughout the Earth's activity sphere.

6. Electric propulsion to transport humans from Earth orbit to Lunar orbits and Libration Points.

7. Electric propulsion to transport humans from any Earth orbit to other planets and their moons.

8. Electric propulsion to transport cargo from low Earth orbit to any other orbit throughout the Earth's activity sphere.

9. Electric propulsion to transport cargo from low Earth orbit to any other orbit throughout the Earth's activity sphere.

10. Electric propulsion to transport cargo from low Earth orbit to any other orbit throughout the Earth's activity sphere.
